(19) United States
(12) Patent Application Publication
(10) Pub. No.: US 2007/0294402 A1
(43) Pub. Date: Dec. 20, 2007

(54) Extensible Email

(75) Inventors: Eliot C. Gillum, Mountain View, CA (US); Joshua T. Goodman, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: MICROSOFT CORPORATION, Redmond, WA (US)

(21) Appl. No.: 11/564,659

(22) Filed: Nov. 29, 2006

Related U.S. Application Data
(63) Continuation of application No. 11/424,379, filed on Jun. 15, 2006.

(51) Int. Cl. G06F 15/173

(52) U.S. Cl. 709/225

(57) ABSTRACT

An email server and systems and methods for providing requested data are provided. The email server is configured to automatically determine capabilities or version information of connecting client software on per account basis. The e-mail server is also configured to store the determined capabilities or version information, and to transmit the determined capabilities or version information.

The present application is a continuation of and claims priority of U.S. patent application Ser. No. 11/424,379, filed Jun. 15, 2006, entitled “Extensible Email”, the content of which is hereby incorporated by reference in its entirety.

### BACKGROUND

Email users often have a long list of desired features which they would like for their email client program to provide, such as encryption, shared presence and profile information, cross-organization calendar sharing that is as simple as within organization sharing, and many others. The needs or desires of various users will differ. Some users would like to be able to share their calendar with their spouse as easily as they share it with their co-workers. Others desire encryption to be able to communicate with their bank, their lawyer, their doctor, etc., without fear of criminals or others spying on them. Some would like to be able to see other's picture, homepage, up-to-date contact information, etc. Still others would like to know whether the recipient of an email they wish to send supports new protocols and formats like IRM, iCal, and even HTML, so that they can send messages that the recipient will understand. Email users would also like to make sure this information is shared only with the people they trust.

One factor that sometimes limits the ability for client email programs to provide various features desired by users relates to potentially limited capabilities of the client email programs used by others with whom the users would like to communicate. Because of various difficulties in determining the capabilities or protocols of email clients used by others, in some instances the addition of new functionality is slowed or prevented altogether. For various reasons, what works well within an organization to address the desire for more email functionality may not work well between organizations or across the internet in general.

In general, today, there is no way to know who supports what protocols and features. For instance, there is no way to know if a recipient supports iCal, or vCal, or yet to be developed calendar standards such as ink or protocols for negotiating location and travel times. There isn't even a way to know if the recipient supports HTML. For instance, when corresponding with people at universities, many senders avoid HTML because a minority—but moderately large portion—of people in academia do not use HTML enabled email clients. Substantially all clients can receive HTML, but a few will display in plain text, so one should not to use features like colors, or underlines, or certain types of hyperlinks. Thus, even features that are deployed in most email clients are avoided, because there is typically no way to know if the recipient supports the feature. Even when features like calendaring are supported, there may be multiple versions of the feature, and it may be very difficult or impossible to tell which version is supported.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

Methods and systems for providing requested data are disclosed. The methods or systems can be implemented, for example, in an email server. Requested data can include free-busy data, information on which people have accepted or declined a meeting, a time zone, human readable notes about a specific date or date range, protocol support information, out-of-office information, whether the recipient wants computational puzzles to be solved, an image, a home page, an instant message client, a preferred language, contact information; and whether an e-mail message is being replied to. To provide requested data, a request for an authentication key is received. In response, the requested authentication key is sent in an e-mail. The authentication key is then received as part of a HTTP, HTTPS or SMTP request for data. The requested data, in response to the HTTP, HTTPS or SMTP request for data, is then sent.

### BRIEF DESCRIPTION OF THE DRAWINGS

FIG. 1 illustrates an embodiment utilizing disclosed concepts.

FIG. 2 is a flow diagram illustrating a method embodiment.

FIG. 3 is a block diagram illustrating a more detailed system or apparatus embodiment.

FIG. 4 is a flow diagram illustrating another method embodiment.

FIG. 5 is a block diagram illustrating another more detailed system or apparatus embodiment.

FIG. 6 is a block diagram illustrating a general computing environment configured to implement disclosed embodiments.

### DETAILED DESCRIPTION

As mentioned, improving email by adding additional features can be difficult to implement on a wide-scale basis due to various difficulties in determining the capabilities or protocols of email clients used by others. One reason that these features can be difficult to implement is that many current email protocols do not support querying. Thus, there are few, if any, suitable methods for one person to find out important information about another—like their email client program's capabilities, their calendar, their public key, etc.—in a fully automated way.

Disclosed embodiments provide a general mechanism for querying the email programs of others. Using disclosed methods, a substantial number of widely desired features can be easily added, and email systems can progress much faster. Examples of such widely desired features include easy cross organization calendar sharing, contact sharing, Secure Multi-Purpose Internet Mail Extensions (S/MIME) encryption and signing, and instant messaging (IM) like features such as shared presence, profile and image information. The sharing can be individual-to-individual, or organization-to-organization, or other combinations.

Disclosed embodiments utilize automatic querying to facilitate the ability to implement desirable email features. This querying can be in the form of a sender asking a recipient for his S/MIME key, or his free-busy data, or his preferred language, or his picture. As will be described in detail, in many cases, this querying also requires some sort of authentication, to make sure that data is only shared with people with the proper permissions. Disclosed embodiments provide such querying and authentication using a new communication channel: a fast bidirectional channel for the sender's client to query the recipient's system.

In some embodiments, this new channel, between the Sender's client, and the recipient's system, is over Hyper Text Transfer Protocol (HTTP) or HTTP with Secure Socket Layer (SSL) encryption (HTTPS). Many email servers already run a web server with access to all of the recipient's data, so this simply means more broadly exposing already available data using web servers that exist today. In some other embodiments, this channel is over the Simple Mail Transport Protocol (SMTP), the most common current email protocol. While SMTP is typically slower than HTTP, all email clients and servers connected to the internet can send data through this protocol (perhaps through additional servers.)

The additional requirement of authentication can be implemented using a simple, one-time email exchange. The first time a sender requests information from a domain, his or her email client (rich email clients or web email clients) sends a special message requesting a secret key or other authenticating information. As used herein, the authentication key is intended to represent both conventional type authentication keys, as well as other types of authenticating information. The domain sends back a key, specific to that email address. While it is trivial to send mail falsely pretending to be from someone, it is typically very hard to intercept mail to someone, so only the sender is capable of receiving his own secret key. Unlike other authentication systems which use email, in disclosed embodiments the use of email to authenticate users is completely automatic. No click on an embedded link or other action is required by the user to generate the request for data once the authentication code or key is received. From then on, whenever the sender wants to request information from that domain, his email client passes his key as part of the request.

There are many different possible ways to implement querying mechanisms. But whether the querying is based on Instant Messaging (IM), LDAP, HTTP, SMTP, SOAP, pub-sub, or some other protocol, the important thing is to create such a protocol, and make it available on email clients and servers. Although example implementations are provided in this disclosure, those of skill in the art will recognize that other embodiments and implementations also fall within the scope of the invention.

In exemplary embodiments, querying is performed over HTTP or HTTPS. HTTP is particularly appropriate, because even users behind restrictive firewalls typically have access through proxy servers. For example, to query information about a user userabc@microsoft.com, disclosed embodiments can be such that a user's email client/server would connect to a server such as http://mailqueryserver.microsoft.com. The actual query might be of the same form as a typical HTTP web query, e.g. to get the free busy information for the user between November 10 and November 20, one might perform a query of the form:

http://mailqueryserver.microsoft.com/emailxquery?name=USERAB C&type=freebusy&from date=11102005 &todate=11202005 &queryfrom=billg@microsoft.com&authid=0x28jc83kd925d
which might return a text document containing the relevant free-busy information (or iCAL format or other formats). Alternatively, the data might be sent using the HTTP POST method.

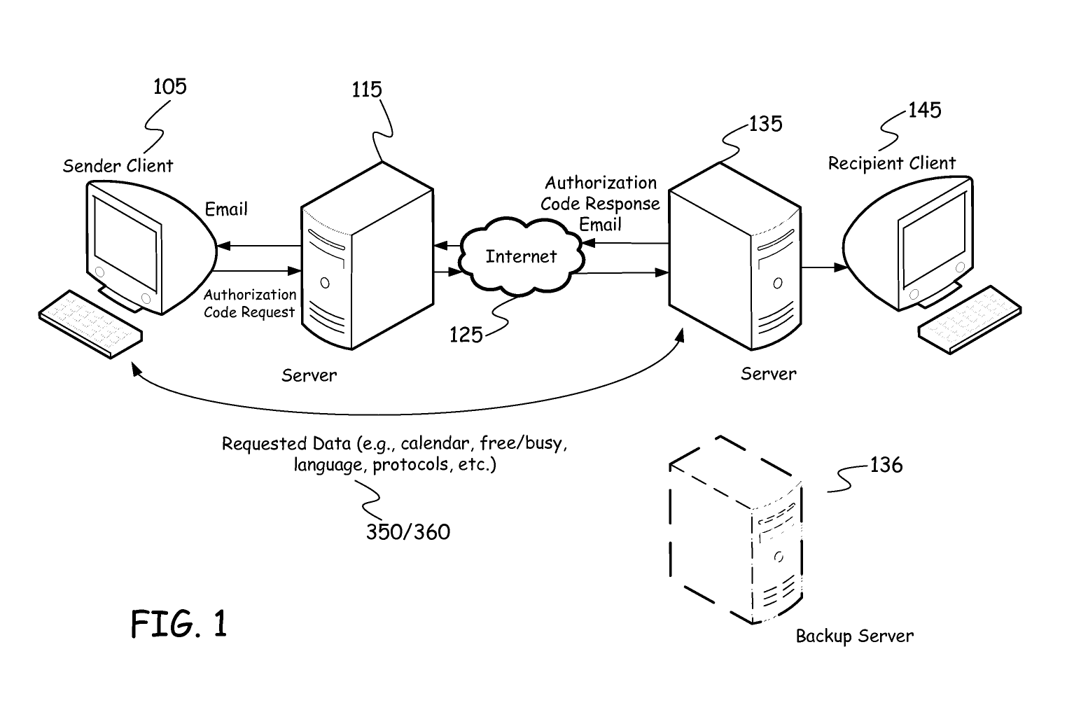

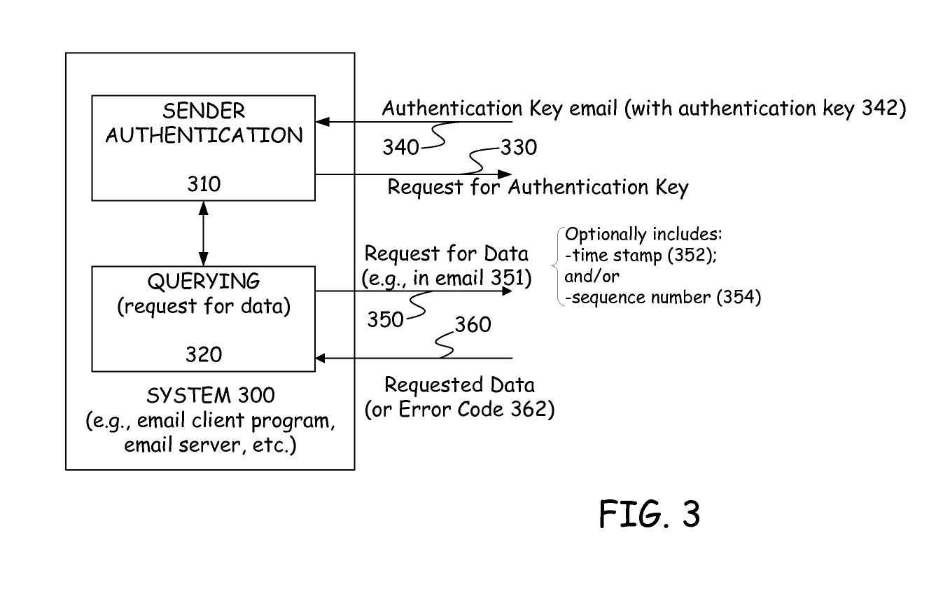

In more general embodiments, disclosed systems can be configured to request data about a party with an email address generally of the form x@example.com by sending a request for data to a recipient server (for example server 135 shown in FIG. 1) of the form y.example.com, for some fixed value of y. If an error code (362 in FIG. 3 described below) is received in response to the request for data, in some embodiments the system then automatically contacts a universal backup server (for example, server 136 in FIG. 1) with the request for data. Using a special address of the form y.example.com (for some fixed value of y) is a particularly advantageous method. The Domain Name System allows arbitrary mappings of host names (like y.example.com) to IP addresses by the domain owner. The domain owner might choose to map y.example.com to an existing mail server, especially if the existing server is upgraded to software that uses the system described herein. Alternatively, they may choose to map the name to a different server that they own, while keeping their email software unchanged. In another alternative, a third party may provide these services, and the domain owner may map this name to an IP address owned by a third party providing this service. In some cases, however, a domain owner may not choose to make any mapping at all. In this case, attempts to find this server will return an error code. Because the maker of email client software might wish to provide functionality even when the owner of a domain does not explicitly enable that functionality, some disclosed embodiments optionally utilize a universal backup server to provide this functionality even in that case.

Users need to be able to control who has access to their information, which means solving the authentication problem. As described above, in disclosed embodiments, the authentication is done via email. This is a one-time step, performed the first time a user communicates with a new domain. To get authentication for a new domain, e.g. the first time a user talks to the domain, an email is sent to the designated domain requesting an authentication key. The authentication server emails back an authentication code or key. This authentication code is used whenever the user communicates to the server. After authentication, the user can make queries about anyone with an email address at that domain, and the recipient server can be sure of who is making the query. Note that the authentication code ensures the identity of the person making the query, but not necessarily what data they have access to—that is, data is only shared with users who both have an authentication code, and who have the permissions to access that data.

Permissioning can be controlled by either or both of individuals and administrators (admins). For instance, an admin could allow sharing of all data in his domain with another domain, or with all members of a distribution list or mailing list. For example, under admin control everyone at Microsoft could share their free-busy data with everyone at a public relations agency, or a law firm. Admins could also override certain types of sharing, e.g. not allowing full text calendar sharing, while allowing other types of sharing such as the sharing of only free-busy data. Authentication and permissioning are separate processes: anyone can engage in the authentication process, which allows them to prove their identity. Permissioning is controlled by users or admins, with the permissioning data stored on a server. Only if no authentication is necessary, or if a user both authenticates and has permission to receive data, is the data provided.

However, this level of authentication will not be acceptable for some enterprise communications systems which require encryption. By sending the response encrypted with the recipient's secret key, and conducting all future correspondence over HTTPS, cryptographic levels of security can be achieved in some disclosed embodiments. In some cases, administrators might decide that certain sensitive data, e.g. free-busy data or full calendars, can only be shared with users who support this encryption. Also, the enterprise secret key can be used to deliver proof-of-freshness with each request, so that in the case of a security problem, permission can quickly be revoked.

Referring now more specifically to FIG. 1, shown is a diagram illustrating aspects of disclosed embodiments in which a user (both user and email client software represented as sender client 105) wishes to find out information for an intended recipient (recipient client 145) on a domain server 135. Server 135 is shown connected to server 115 of the sender client 105 via the internet 125, though this need not be the case in all embodiments. Other computer networks could be used in place of internet 125. The email client 105 of a user is configured to function as described above to request an authentication key or code from server 135. In some embodiments, if server 135 returns an error code 362, email client 105 automatically sends the request for an authentication key to a universal backup server 136 as described above. In some embodiments, the backup server is used when a requesting system does not get a response from the server 135, e.g. timeout or name doesn't exist. These embodiments relate the case where, if server 135 is there to give an error code, there may be a high likelihood that it is not worth retrying the query elsewhere.

Once an authentication key is returned, a request for data is automatically sent to server 135 (or server 136) with the authentication key. The server 135/136 will then return the requested data concerning the intended recipient and/or the recipient's email client 145.

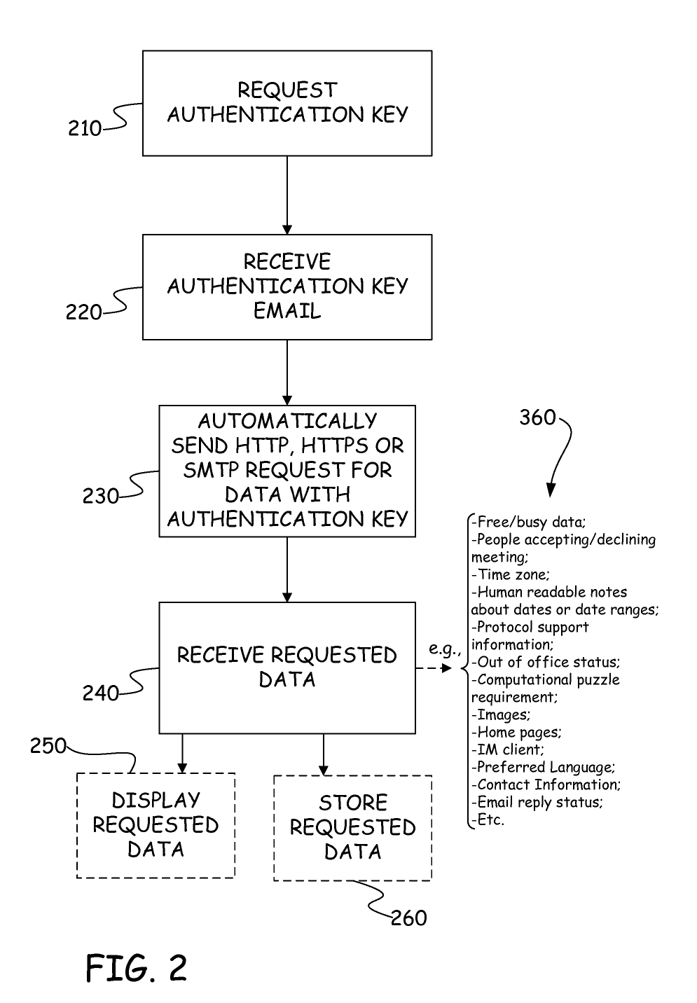

Referring now to FIGS. 2 and 3, more detailed embodiments are described. FIG. 2 is a block diagram illustrating a method for obtaining data. The method, which has been summarized above, includes the step 210 of requesting an authentication key 342. As shown in FIG. 3, in an example embodiment of a system 300 (for example an email client program or server), an authentication requesting component 310 sends this request (represented at 330). Then, at step 220 shown in FIG. 2, the authentication key 342 is received by component 310 in the form of an email 340.

Next, as shown at step 230, in disclosed embodiments the system automatically sends the authentication key as part of a HTTP, HTTPS or SMTP request for data 350. In the example embodiment illustrated in FIG. 3, this request for data is generated by querying component 320 of the system 300. When the queried server (e.g., server 135 in FIG. 1) returns the requested data 350, it is received by querying component 320. The step of receiving the requested data is illustrated in FIG. 2 at reference number 240. Once received, the requested data can be saved as shown at optional step 260, and/or shown in some representational form at step 250 (e.g., displaying capabilities of recipient client 145, displaying calendar information, etc.).

In some embodiments, included with the request for data 350 is one or both of a timestamp 352 and a sequence number 354. In these embodiments, the recipient server 135 can be configured to provide additional data in the requested data 360 if the requested data has changed since the timestamp or sequence number. Thus, updates for a recipient can be obtained periodically.

In various embodiments, the requested data 360 can include a wide variety of information. For example, the requested data can include: free-busy data from the recipients calendar; information on which people have accepted or declined a meeting; a time zone (e.g., of a recipient, or a meeting, etc.); human readable notes about a specific date or date range; information about protocol support; information indicative of whether a party is out-of-office; whether a recipient wants computational puzzles to be solved for anti-spam systems; an image; a home page; an instant messaging client; a preferred language; contact information; and/or whether an email message is being replied to. Other data can also be requested within the scope of disclosed embodiments.

Now, a description is provided for another aspect of data 360, computational puzzles. Some email clients may include computational puzzles: for certain outgoing messages, a time consuming puzzle will be solved, and the puzzle solution attached to the message (see, e.g., HashCash). This proof of effort will help the message past the recipient spam filter. But whenever the recipient spam filter does not recognize the puzzle, this effort will be wasted. Whenever the sender is already on the recipient's safe list, the effort is also wasted. And if the recipient decides to require a more time-consuming puzzle, the computation may be insufficient. With querying capabilities, the sender can ask the recipient if he is safe-listed, and also ask how much computation is required if not. Some economic analyses show that without this capability, the puzzles may be too easy, and abusable by spammers, or too time consuming, and overly slow down most email transactions. Knowing the recipient's policy lets users solve hard puzzles in the rare cases when necessary, so that only a few transactions are substantially slowed, making puzzle solving economically reasonable.

Next, a description is provided for another aspect of data 360, out of office status. In some disclosed embodiments, as soon as a person's name is entered in the TO line of an email client, the user is able to see the person's Out of Office information, before composing a long message to them. Data 360 may include this out of office information, and process 200 (perhaps starting at step 230) may be triggered in response to entering information on the To: or CC: or BCC: line of an email message.

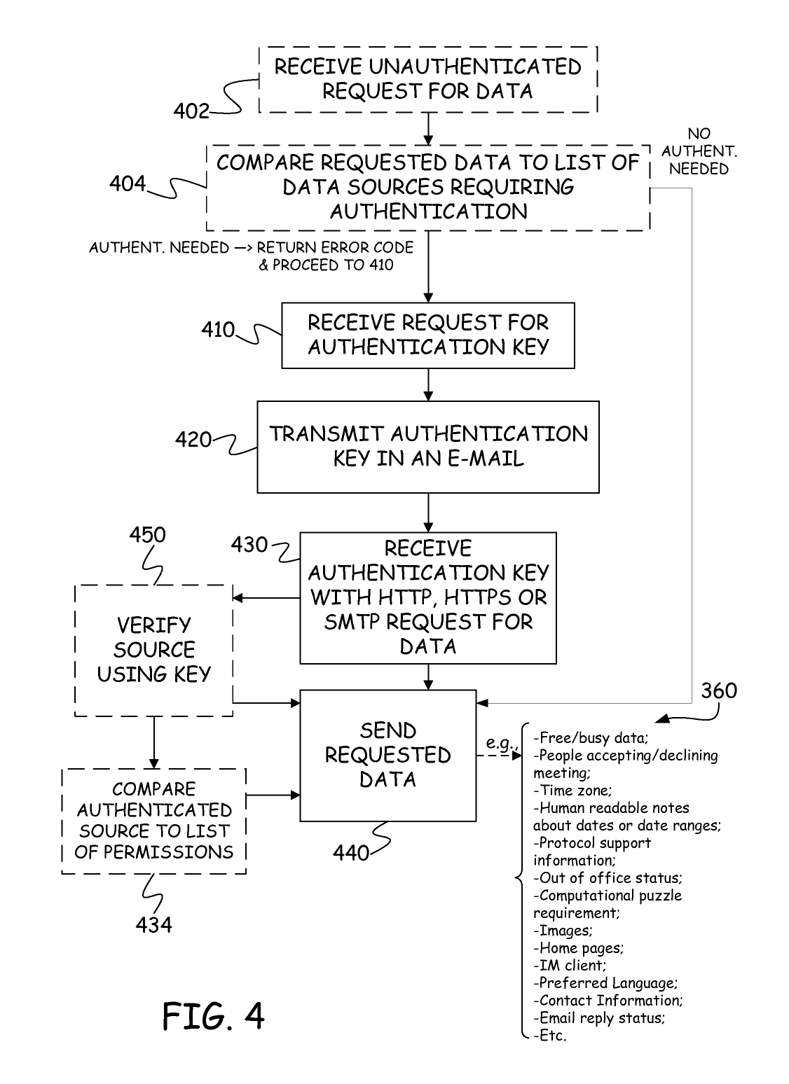

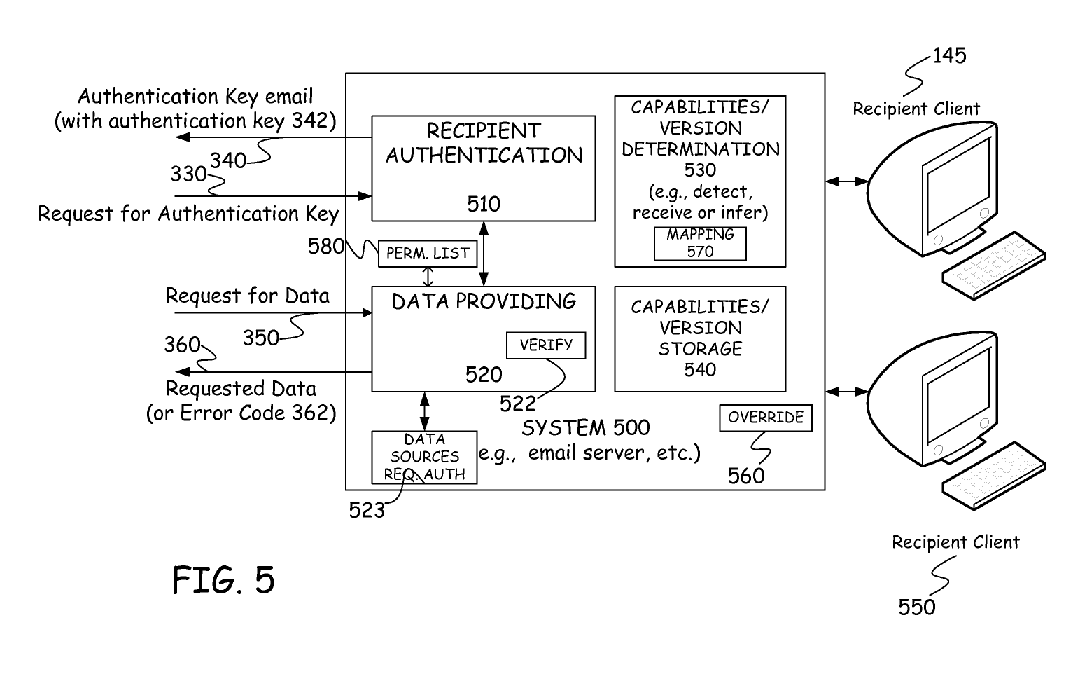

While FIGS. 2 and 3 illustrates methods from the sender's email client and/or server perspective, FIGS. 4 and 5 illustrate disclosed methods and systems from the recipient server's perspective. For example, referring to the flow diagram shown in FIG. 4, at step 410 a method is illustrated as including receiving a request 330 for an authentication key 342. In the embodiment illustrated in FIG. 5, this is performed by authentication providing component 510 of system 500. System 500 can be, for example, implemented as part of recipient server 135. Component 510 also sends the requested authentication key 342 in an email 340 as was discussed above. This corresponds to step 420 in FIG. 4.

Next, as illustrated at step 430, the method of FIG. 4 includes receiving the authentication key as part of a HTTP, HTTPS or SMTP request for data 350. This request for data is received in system 500 by data providing component 520. In some embodiments, if the authentication key matches that expected by system 500, the sender client is verified as shown at 522 in FIG. 5 and at optional (in some embodiments) step 450 in FIG. 4, and the requested data 360 is returned as described above. This is represented at step 440 of FIG. 4.

In some embodiments, the method includes further or alternate steps. These steps are shown in FIG. 4 in dashed lines indicating their optional (in some embodiments) nature. For example, as shown at 402 in FIG. 4, an unauthenticated request for data is received. Then, at step 404, the requested data is compared to a list 523 (shown in FIG. 5) of data sources that require authentication. If no authentication for the requested data is required, the method can proceed immediately to step 440 of sending the requested data, without authenticating the source of the request. If authentication is needed, and error code can be returned to the requesting system, and the process can proceed to step 410. These steps can be implemented generally by system 500, and in one more specific embodiment by data providing component 520. Authenticating component 510 can also be configured to perform these steps in embodiments. As noted above, optionally, the process can begin at step 410 instead of at step 402.

In further embodiments, as shown at 434 in FIG. 4, a step is included in which the authenticated source is compared to a list 580 of permissions (shown in FIG. 5). The permissions may be set by the user, or by the administrator on a per domain (allowing access to all users from a particular domain) or per user bases. The list of permissions then dictates what data can be sent to the requester. The further optional step 434 is implemented by system 500 in general, and in more specific embodiments, can be implemented by either of authenticating component 510 or data providing component 520, for example.

FIG. 5 also shows other aspects of some disclosed embodiments. For example, system 500, which can be an email server such as recipient server 135, is also configured to automatically determine capabilities or version information of connecting client software (e.g., connecting client software represented at 145 and/or 550) on a per account basis. This capabilities determining step or functionality is illustrated at 530, and can include, for example, determining capabilities by detecting, receiving or inferring the capabilities or version information from the client software. In some embodiments, for example, system 500 is configured to determine capabilities by detecting a version of the client software. Then, a mapping 570 between the client software version and a capabilities list is used to determine capabilities of the client. Once determined, the capabilities or version information is stored as represented at 540. With server or system 500 collecting the capabilities and/or version information for its clients, this information is available for transmission 440 in response to a request for data.

In some embodiments, users and/or administrators are provided the ability to block the transmission of their client's capabilities, their other information, or other aspects. Often, administrators would want control over these verticals more than users. This can be done using an override setting 560, which can be controlled for example using a preferences setting on the recipient client program. When the override is present, the email server will not transmit the determined capabilities, version information and/or other aspects as controlled by the administrator or by the user.

### Alternative Extensibility Options

A brief description of some alternative extensibility mechanisms that already exist, and alternatives new proposals, like pub-sub, are now provided. There are a number of extensibility options that exist for email today. These include adding headers to information and adding MIME attachments. Both of these allow extra information to be sent, but neither allows for information to be queried. An examination of the list of features that require querying shows that some could be partially solved by extra headers or extra MIME data, but in most instances, if not in all instances, not as well as with disclosed querying approaches. Another extensibility mechanism that exists today is the SMTP EHLO command. Unfortunately, EHLO is a server only command: There is no existing way for a client to leverage EHLO. Because of that, and other technical limitations, extensibility built using EHLO is generally not available or is unknown.

Yet another extensibility proposal uses client only communications, with a pub-sub model. This has a few advantages (there is no need for a server), but the server-based approach has an even larger number of advantages, including better behavior in client-only models.

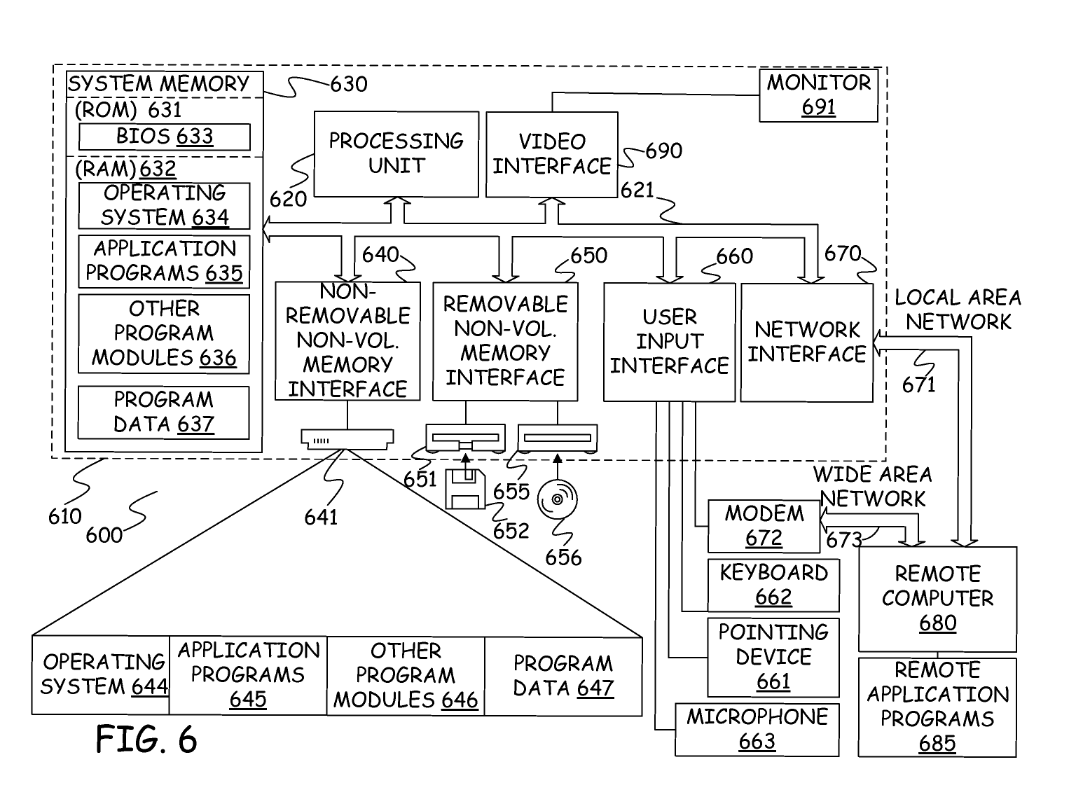

FIG. 6 illustrates an example of a suitable computing system environment 600 on which the concepts herein described may be implemented. The computing system environment 600 is again only one example of a suitable computing environment and is not intended to suggest any limitation as to the scope of use or functionality of the description below. Neither should the computing environment 600 be interpreted as having any dependency or requirement relating to any one or combination of components illustrated in the exemplary operating environment 600.

In addition to the examples herein provided, other well known computing systems, environments, and/or configurations may be suitable for use with concepts herein described. Such systems include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The concepts herein described may be embodied in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The concepts herein described may also be practiced in distributed computing environments where tasks are performed by remote processing devices that are linked through a communications network. In a distributed computing environment, program modules may be located in both locale and remote computer storage media including memory storage devices.

With reference to FIG. 6, an exemplary system includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 600.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635 (for example email and other client programs and email server software), other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies.

A user may enter commands and information into the computer 610 through input devices such as a keyboard 662, a microphone 663, and a pointing device 661, such as a mouse, trackball or touch pad. Other input devices (not shown) may include a scanner or the like. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690.

The computer 610 may operate in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a locale area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user-input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

It should be noted that the concepts herein described can be carried out on a computer system such as that described with respect to FIG. 6, and FIG. 6 should be interpreted as being configured to carry out one or more of these various concepts. However, other suitable systems include a server, a computer devoted to message handling, or on a distributed system in which different portions of the concepts are carried out on different parts of the distributed computing system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for providing requested data, the method comprising:
receiving a request for an authentication key;
sending the requested authentication key in an email;
receiving the authentication key as part of a HTTP, HTTPS or SMTP request for data; and
sending the requested data in response to the HTTP, HTTPS or SMTP request for data, wherein the requested data includes at least one of the following: free-busy data, information on which people have accepted or declined a meeting, a time zone, human readable notes about a specific date or date range, protocol support information, out-of-office information, whether the recipient wants computational puzzles to be solved, an image, a home page, an instant messaging client, a preferred language, contact information; and whether an email message is being replied to.

2. The computer-implemented method of claim 1, wherein the steps of receiving the request for the authentication key, sending the requested authentication key in the email, receiving the authentication key as part of the request for data, and sending the requested data are performed by an email server.

3. The computer-implemented method of claim 1, wherein the data is information on which people have accepted or declined a meeting, a time zone, human readable notes about a specific date or date range

4. The computer-implemented method of claim 1, wherein the data is an image, a home page, or instant messaging support.

5. The computer-implemented method of claim 2, wherein the request for the authentication key and the request for data are originated by an email client program.

6. The computer-implemented method of claim 1, and prior to the step of sending the requested data, further comprising verifying a source of the request for data using the authentication key.

7. A system for providing requested data, the system comprising:
an authentication providing component configured to receive a request for an authentication key, and in response to send the requested authentication key in an email;
a data providing component configured to receive the authentication key as part of a HTTP, HTTPS or SMTP request for data, and in response to the request for data to send the requested data, wherein the requested data includes at least one of the following: free-busy data, information on which people have accepted or declined a meeting, a time zone, human readable notes about a specific date or date range, protocol support information, out-of-office information, whether the recipient wants computational puzzles to be solved, an image, a home page, an instant messaging client, a preferred language, contact information, and whether an email message is being replied to.

8. The system of claim 7, wherein the authentication providing component and the data providing component are components of an email server.

9. The system of claim 7, wherein the data providing component is further configured to verify a source of the request for data using the authentication key, and to send the requested data only after verifying the source of the request for data.

10. The system of claim 9, wherein the source is checked against a list of email addresses or domain names.

11. The system of claim 9, wherein the data includes at least one of contact information, and whether an email message is being replied to.

12. An email server configured to automatically determine capabilities or version information of connecting client software on per account basis, to store the determined capabilities or version information, and to transmit the determined capabilities or version information.

13. The email server of claim 12, wherein the email server is configured to determine the capabilities or version information by detecting, receiving or inferring the capabilities or version information.

14. The email server of claim 12, wherein the email server is configured to transmit the determined capabilities or version information in response to a request for data from an email client program of another party.

15. The email server of claim 14, wherein the email server is configured to transmit the determined capabilities or version information in response to a request for data, from the email client program, which includes an authentication key.

16. The email server of claim 12, wherein the email server is configured to transmit the capabilities or version information over HTTP, HTTPS or SMTP.

17. The email server of claim 12, wherein the email server is configured such that if multiple clients connect to the email server, the email server transmits a state of partial support.

18. The email server of claim 12, wherein the email server is configured such that, in response to an override from a user, the email server will not transmit the determined capabilities or versions information.

19. The email server of claim 18, wherein the capabilities or version information pertains to the user who provides the override.

20. The email server of claim 12, wherein the email server is configured to determine capabilities by detecting a version of client software and using a mapping between client software version and a capabilities list.
